(19) United States
(12) Patent Application Publication
(10) Pub. No.: US 2016/0292961 A1
(43) Pub. Date: Oct. 6, 2016

(54) VIDEO GAME PROCESSING PROGRAM, VIDEO GAME PROCESSING SYSTEM

(71) Applicant: KABUSHIKI KAISHA SQUARE ENIX (also trading as SQUARE ENIX CO., LTD.), Tokyo (JP)

(72) Inventor: Naoki HAMAGUCHI, Tokyo (JP)

(73) Assignee: KABUSHIKI KAISHA SQUARE ENIX (also trading as SQUARE ENIX CO., LTD.), Tokyo (JP)

(21) Appl. No.: 15/085,268

(22) Filed: Mar. 30, 2016

(30) Foreign Application Priority Data
Apr. 1, 2015 (JP) 2015-075488

(51) Int. Cl. G07F 17/32

(52) U.S. Cl. CPC G07F 17/3227

(57) ABSTRACT

A non-transitory computer-readable medium including a video game processing program product for causing a server to realize functions to control progress of a video game is provided. An in-game element for which a plurality of evolutive steps are provided appears in the video game. The functions include: a selecting function to select at least one in-game element from a plurality of in-game elements in accordance with a predetermined rule in response to a selection request from the user; an adjusting function to refer to a storage section, in which information regarding the in-game element is stored, to adjust a predetermined adjustment target so that the in-game element becomes a predetermined evolutive step or higher when the in-game element is given to the user on the basis of a selection result; and a giving function to give the user the in-game element as the selection result or the in-game element as an adjustment result.

### CROSS-REFERENCE TO RELATED APPLICATION

The present application relates to subject matter contained in Japanese Patent Application No. 2015-075488 field on Apr. 1 2015, the disclosure of which is expressly incorporated herein by reference in its entirety.

### BACKGROUND OF THE INVENTION

1. Field of the Invention

At least one of embodiments according to the present invention relates to a non-transitory computer-readable medium including a video game processing program and a video game processing system for causing a server to realize functions to control progress of a video game in which an in-game element for which a plurality of evolutive steps are provided appears.

2. Description of the Related Art

Heretofore, various kinds of systems, each of which causes a user to carry out prize lots in which various kinds of items are set up to prizes (gacha), have been proposed in a technical field of a video game.

In such a system, for example, there is one configured so that in a case where an item is given to a user by means of a lottery, a privilege is given to the user when all of predetermined items are given to the user (see Japanese Patent Application Publication No. 2013-240567).

However, in the conventional system, an item to be given to the user by a lottery is determined among a predetermined group of items each of which a lottery probability is set up. For this reason, it is not necessarily that the user obtains an item desired by the user. There has been a problem that this can become motivation to carry out a lottery in order to obtain an item with a high rarity in a video game, but this may become a reason to decrease a desire of the user to carry out a lottery. Namely, in the conventional system, for example, an item that can be obtained in the time of low progress of the video game may be determined by lot for even a user with high progress of the video game. For this reason, the higher the user has progress of the video game, the more the desire to the lottery may be lowered. Further, such a problem is not limited to the lottery of an item, but is common to a video game in which various kinds of in-game elements to be given to a user exist.

### SUMMARY OF THE INVENTION

It is an object of at least one of embodiments according to the present invention to solve the problem described above, and to provide a user with a video game by which motivation of the user to a lottery of an in-game element can be improved.

According to one non-limiting aspect of the present invention, there is provided a non-transitory computer-readable medium including a video game processing program product for causing a server to realize functions to control progress of a video game. In this case, an in-game element for which a plurality of evolutive steps are provided appears in the video game. Further, the server includes a storage section configured to store information regarding the in-game element so as to be associated with a user, the information being information related to the user.

The functions include a selecting function configured to select at least one in-game element from a plurality of in-game elements in accordance with a predetermined rule in response to a selection request from the user.

The functions also include an adjusting function configured to refer to the storage section to adjust a predetermined adjustment target so that the in-game element becomes a predetermined evolutive step or higher when the in-game element is given to the user on the basis of a selection result by the selecting function.

The functions also include a giving function configured to give the user the in-game element as the selection result by the selecting function or the in-game element as an adjustment result by the adjusting function.

According to another non-limiting aspect of the present invention, there is provided a video game processing system including a communication network, a server and a user terminal. In this case, the video game processing system is configured to control progress of a video game, an in-game element for which a plurality of evolutive steps are provided appearing in the video game.

The video game processing system includes a storing section configured to store information regarding the in-game element so as to be associated with a user, the information being information related to the user.

The video game processing system also includes a selecting section configured to select at least one in-game element from a plurality of in-game elements in accordance with a predetermined rule in response to a selection request from the user.

The video game processing system also includes an adjusting section configured to refer to the storage section to adjust a predetermined adjustment target so that the in-game element becomes a predetermined evolutive step or higher when the in-game element is given to the user on the basis of a selection result by the selecting section.

The video game processing system also includes a giving section configured to give the user the in-game element as the selection result by the selecting section or the in-game element as an adjustment result by the adjusting section.

According to still another non-limiting aspect of the present invention, there is provided a non-transitory computer-readable medium including a video game processing program product for causing a user terminal to realize functions to control progress of a video game, an in-game element for which a plurality of evolutive steps are provided appearing in the video game, the user terminal communicating with a server, the server comprising a storage section configured to store information regarding the in-game element so as to be associated with a user, the information being information related to the user.

The server includes a selecting function configured to select at least one in-game element from a plurality of in-game elements in accordance with a predetermined rule in response to a selection request from the user

The server also includes an adjusting function configured to refer to the storage section to adjust a predetermined adjustment target so that the in-game element becomes a predetermined evolutive step or higher when the in-game element is given to the user on the basis of a selection result by the selecting function.

The server also includes a giving function configured to give the user the in-game element as the selection result by the selecting function or the in-game element as an adjustment result by the adjusting function.

The functions includes a receiving function configured to receive, from the server, information for outputting a game screen indicating a giving result by the giving function.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a video game processing system corresponding to at least one of embodiments according to the present invention.

FIG. 2 is a block diagram showing a configuration of a video game processing server corresponding to at least one of the embodiments according to the present invention.

FIG. 3 is a flowchart showing an example of game processing corresponding to at least one of the embodiments according to the present invention.

FIG. 4 is a flowchart showing an example of an operation of a server side in game processing corresponding to at least one of embodiments according to the present invention.

FIG. 5 is a flowchart showing an example of an operation of a terminal side in the game processing corresponding to at least one of the embodiments according to the present invention.

FIG. 6 is a block diagram showing a configuration of the video game processing server corresponding to at least one of the embodiments according to the present invention.

FIG. 7 is a flowchart showing an example of the game processing corresponding to at least one of the embodiments according to the present invention.

FIG. 8 is a block diagram showing a configuration of the video game processing server corresponding to at least one of the embodiments according to the present invention.

FIG. 9 is a flowchart showing an example of the game processing corresponding to at least one of the embodiments according to the present invention.

FIG. 10 is a block diagram showing a configuration of the video game processing server corresponding to at least one of the embodiments according to the present invention.

FIG. 11 is a flowchart showing an example of the game processing corresponding to at least one of the embodiments according to the present invention.

FIG. 12 is a block diagram showing a configuration of the video game processing server corresponding to at least one of the embodiments according to the present invention.

FIG. 13 is a flowchart showing an example of the game processing corresponding to at least one of the embodiments according to the present invention.

FIG. 14 is a block diagram showing a configuration of the video game processing server corresponding to at least one of the embodiments according to the present invention.

FIG. 15 is a flowchart showing an example of the game processing corresponding to at least one of the embodiments according to the present invention.

FIG. 16 is a block diagram showing a configuration of the video game processing server corresponding to at least one of the embodiments according to the present invention.

FIG. 17 is an explanatory drawing for explaining an example of a storage state of information corresponding to at least one of the embodiments according to the present invention.

FIG. 18 is a flowchart showing an example of the game processing corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like does not occur. Further, explanation of the content that will be described as an example of an embodiment maybe omitted in another embodiment. Further, the content of operations and/or processing with no relationship to characteristic portions of each embodiment may be omitted. Moreover, various kinds of processing that constitute various kinds of processing flows (will be described below) maybe carried out in random order in a range where contradiction or the like does not occur in the content of the processing.

### First Embodiment

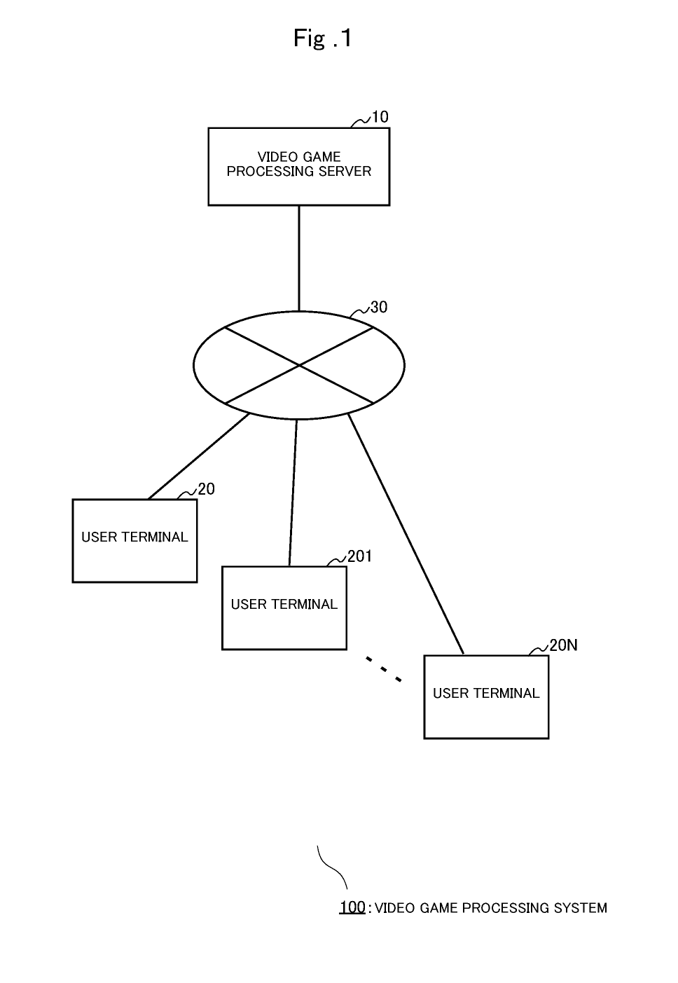

FIG. 1 is a block diagram showing an example of a configuration of a video game processing system 100 according to one embodiment of the present invention. As shown in FIG. 1, the video game processing system 100 includes a video game processing server 10, and user terminals 20 and 201 to 20N (“N” is an arbitrary integer) respectively used by a plurality of users (players) who play a video game. In this regard, the configuration of the video game processing system 100 is not limited to this configuration. The video game processing system 100 may be configured so that the plurality of users uses a single user terminal, or may be configured so as to include a plurality of servers.

Each of the video game processing server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 includes the video game processing server 10 and the plurality of user terminals 20, 201 to 20N, whereby various kinds of functions for controlling progress of the video game, in which an in-game element for which a plurality of evolutive steps are provided appears, in response to an operation of the user are realized.

Here, the in-game element means an element that the user utilize in the video game. Further, the plurality of evolutive steps means that it can be changed (that is, evolved) from a lower step to an upper step by satisfying a predetermined evolutive condition. Therefore, the in-game element according to the present embodiment is changed from one state to other state by satisfying the predetermined evolutive condition. In this case, it can be said that the “one state” is “a lower step” with respect to the “other state” and the “other state” is “an upper step” with respect to the “one state”. In this regard, a configuration of the in-game element is not limited particularly. However, it is preferable that the configuration is a configuration in which the user is allowed to virtually possess a plurality of in-game elements. As examples of the in-game element, there are various kinds of in-game items and in-game characters for each of which a plurality of evolutive steps are provided.

The video game processing server 10 is managed by an administrator of the video game processing system 100, and has various kinds of functions to provide information regarding the video game to the plurality of user terminals 20, 201 to 20N. In the present embodiment, the video game processing server 10 is constructed by an information processing apparatus, such as a WWW server, and includes a storage medium for storing various kinds of information. In this regard, the video game processing server 10 is provided with a general configuration for carrying out the video game, such as a control section and a communicating section. However, its explanation herein is omitted. Further, in the video game processing system 100, it is preferable that the video game processing server 10 manages information regarding the video game from a point of view to reduce a processing load on each of the plurality of user terminals 20, 201 to 20N. However, the storing section for storing the various kinds of information may include a storage region with a state that the video game processing server 10 can access the storage region. For example, the video game processing server 10 may be configured so as to be provided with a dedicated storage region outside the video game processing server 10.

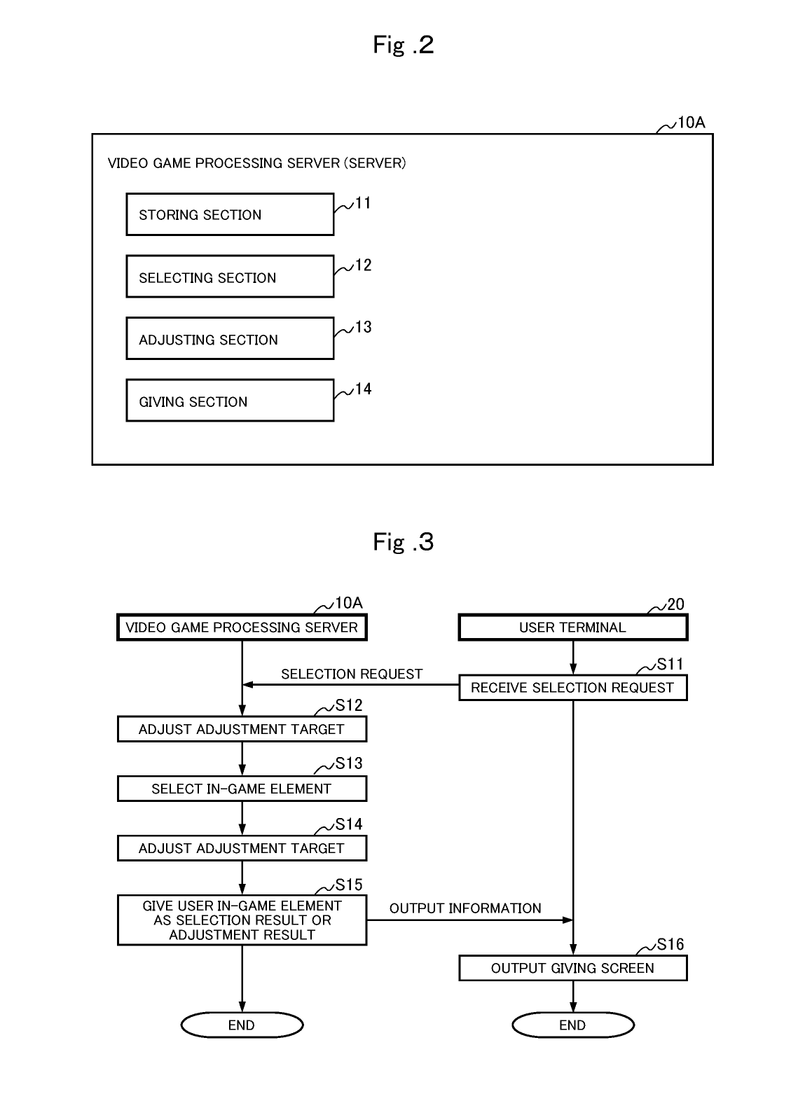

FIG. 2 is a block diagram showing a configuration of a video game processing server 10A (hereinafter, referred to as a “server 10A”) that is an example of the configuration of the video game processing server 10. The server 10A at least includes a storage section 11, a selecting section 12, an adjusting section 13, and a giving section 14.

The storage section 11 has a function to store information regarding the in-game element so as to be associated with the user. The information regarding the in-game element is also information related to the user (hereinafter, referred to as “user related information”).

Here, the information regarding the in-game element means information at least capable of specifying the in-game element. Further, the information related to the user means that the information is information for which association with the user in the video game is recognized. Namely, the user related information according to the present embodiment means information indicating the in-game element in which a predetermined relationship to the user is certified in the video game. In this regard, as examples of the predetermined relationship, there are a relationship that the user possesses or has possessed, and a relationship that the user possesses or has possessed by evolving the in-game element.

The selecting section 12 has a function to select at least one in-game element from a plurality of in-game elements in accordance with a predetermined rule in response to a selection request from the user.

Here, the content of the predetermined rule is not limited particularly. However, it is preferable that the video game processing system 100 is configured so that the user cannot restrict the in-game element to be selected to one kind. Namely, it is preferable that the selecting section 12 has a function to draw the predetermined number of in-game elements from the plurality of in-game elements (a so-called function for realizing “gacha”). As an example of the predetermined rule, there is a rule in which it is defined to select one in-game element on the basis of a probability set up to each of the plurality of in-game elements, which is a selection target.

Further, the selection request from the user means that the user (or player) who plays the video game inputs a predetermined operation in a predetermined scene of the video game. A configuration to receive a selection request is not limited particularly. However, it is preferable that consumption of an in-game item is required for a selection request.

The adjusting section 13 has a function to refer to the storage section 11 to adjust a predetermined adjustment target so that an in-game element to be given becomes a predetermined evolutive step or higher when the in-game element is given to the user on the basis of the selection result by the selecting section 12.

Here, a condition of the predetermined evolutive step is not limited particularly. However, it is preferable that the condition is a condition by which it is thought that it is possible to maintain or improve motivation of the user to the lottery of a game medium. As an example of the predetermined evolutive step, there is an evolutive step of the in-game element that the user possesses or has possessed.

Further, the word “adjust an adjustment target” means that information defined as a target to be adjusted (that is, the adjustment target) is put into a state suitable for a purpose. The content of the adjustment is not limited particularly. However, it is preferable that the content of the adjustment is content by which a processing load on the video game processing system 100 with respect to the adjustment does not become excessively. As examples of the content of the adjustment, there are exclusion and replacement of the in-game element that does not fit the purpose.

Further, the information defined as the adjustment target may be information before selection by the selecting section 12 is carried out, or may be information after the selection by the selecting section 12 was carried out. Namely, the video game processing system 100 may be configured so that a target selected by the selecting section 12 (that is, the selection target) is defined as the adjustment target. Alternatively, the video game processing system 100 may be configured so that a result selected by the selecting section 12 (that is, the selection result) is defined as the adjustment target. In this regard, in a case where it is configured so that the selection result is defined as the adjustment target, the in-game element is specified as the adjustment result. Hereinafter, a case where the user and the adjustment target are managed so as to be associated with each other will be described as an example.

The giving section 14 has a function to give the user the in-game element as the selection result by the selecting section 12 or the in-game element as the adjustment result by the adjusting section 13.

Here, the word “give the user the in-game element” means that predetermined information is updated so that the in-game element is put into a state where the in-game element is given to the user.

Each of the plurality of user terminals 20, 201 to 20N is managed by a user (or a player) who plays the video game, and is configured by a communication terminal, such as a cellular phone terminal, a PDA (Personal Digital Assistants), and a mobile game device, by which the user can play a network delivery type game, for example. In this regard, the configuration of the user terminal that the video game processing system 100 can include is not limited to the examples described above. However, the user terminal may be configured so that the user can recognize the video game. As the other example of the configuration of the user terminal, there is a so-called wearable divide such as a smart watch, a combination of the wearable device and the communication terminal, and the like.

Further, each of the plurality of user terminals 20, 201 to 20N is connected to the communication network 30, and includes hardware (for example, the display device for displaying a game screen, an audio output device and the like) and software for carrying out the video game by communicating with the video game processing server 10. In this regard, each of the plurality of user terminals 20, 201 to 20N may be configured so as to be capable of directly communicating with each other without the video game processing server 10. Further, the configuration in which each of the plurality of user terminals 20, 201 to 20N receives the user operation includes at least a touch panel corresponding to the game screen.

Next, an operation of a video game processing system 100 (hereinafter, referred to as a “system 100”) according to the present embodiment will be described.

FIG. 3 is a flowchart showing an example of game processing carried out by the system 100. In the game processing according to the present embodiment, a process associated with an operation in which an in-game element is given to a user in response to a selection request from the user is carried out. Hereinafter, a case where the server 10A and the user terminal 20 (hereinafter, referred to as the “terminal 20”) carry out the game processing as a process related to a cloud game will be described as an example.

The game processing is started in a case where a predetermined selection request receiving screen is displayed in the terminal 20, for example. Hereinafter, a case where the terminal 20 displays a predetermined selection request receiving screen in response to an operational input by the user who operates the terminal 20 will be described as an example.

In the game processing, the terminal 20 first receives a selection request (Step S11). In the present embodiment, the terminal 20 determines that a selection request is received in a case where the user selects a selection button displayed on the selection request receiving screen; and transmits the selection request containing identification information of the user to the server 10A.

When the selection request is received from the terminal 20, the server 10A adjusts an adjustment target on the basis of the received selection request (Step S12). In the present embodiment, in a case where the adjustment target corresponding to the user of the terminal 20 is a selection target, the server 10A adjusts the adjustment target. On the other hand, in a case where the adjustment target corresponding to the user is a selection result, the server 10A does not carry out the adjustment herein.

Subsequently, the server 10A selects an in-game element (Step S13). In the present embodiment, the server 10A selects at least one in-game element from predetermined selection targets (that is, one in-game element or a plurality of in-game elements) In this regard, in a case where the selection target is adjusted at this time, the server 10A selects an in-game element from selection targets after adjustment.

When the in-game element is selected, the server 10A adjusts the adjustment target (Step S14). In the present embodiment, in a case where the adjustment target corresponding to the user of the terminal 20 is a selection result, the server 10A adjusts the adjustment target.

When the adjustment target is adjusted, the server 10A gives the user the in-game element as the selection result or adjustment result (Step S15). In the present embodiment, in a case where the adjustment target is not the selection result, the server 10A gives the user the in-game element as the selection result. On the other hand, in a case where the adjustment target is the selection result, the server 10A gives the user the in-game element as the adjustment result. Further, in the present embodiment, the server 10A generates information (hereinafter, referred to as “output information”) for causing the terminal 20 to output a screen (hereinafter, referred to as a “giving screen”) for causing the user to recognize the in-game element given to the user, and transmits the generated output information to the terminal 20.

When the output information is received from the server 10A, the terminal 20 outputs the giving screen on the basis of the received output information (Step S16), and terminates the processing herein.

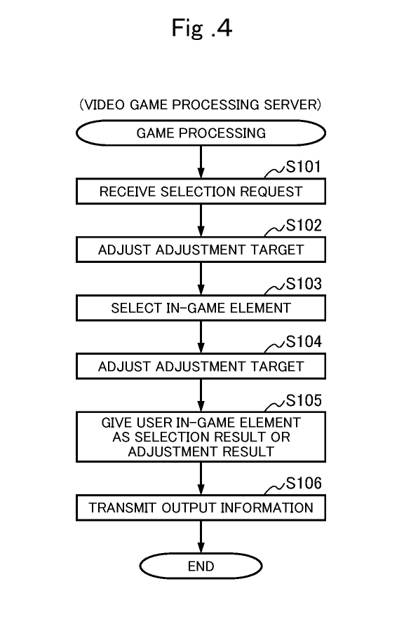

FIG. 4 is a flowchart showing an example of an operation of the server 10A side in the game processing. Here, an operation of the server 10A in the video game processing system 100 will be described again.

In the game processing, the server 10A first receives a selection request (Step S101) ; adjusts an adjustment target appropriately (Step S102) ; and selects an in-game element from a selection target or an adjustment result (Step S103).

When the in-game element is selected, the server 10A adjusts the adjustment target appropriately (Step S104) ; gives the user the in-game element as the selection result or the adjustment result (Step S105) ; transmits, to the terminal 20, information for causing the terminal 20 to output a game screen according to the in-game element thus given (the output information) (Step S106); and terminates the processing herein.

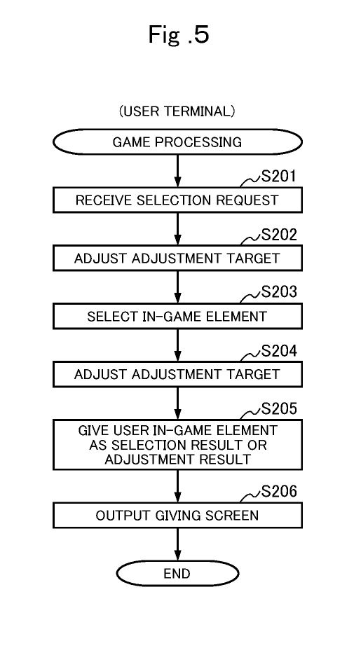

FIG. 5 is a flowchart showing an example of an operation of the terminal 20 side when the terminal 20 carries out the game processing. Hereinafter, a case where the terminal 20 alone carries out the game processing will be described as an example.

The terminal 20 receives a selection request (Step S201) ; adjusts an adjustment target appropriately (Step S202); and selects an in-game element from a selection target or an adjustment result (Step S203). In the present embodiment, the terminal 20 refers to information stored in a storage device with which the terminal 20 is provided, and carries out adjustment of the adjustment target and selection of the in-game element from the selection target.

When the in-game element is selected, the terminal 20 adjusts the adjustment target appropriately (Step S204); and gives the user the in-game element as the selection result or the adjustment result (Step S205). In the present embodiment, the terminal 20 gives the in-game element to the user by updating the user information stored in the storage device with which the terminal 20 is provided.

When the in-game element is given to the user, the terminal 20 outputs a game screen according to the in-game element thus given (Step S206), and terminates the processing herein.

As explained above, as one side of the first embodiment, the video game processing server 10A for controlling progress of the video game in which an in-game element for which a plurality of evolutive steps are provided appears is configured to include the storage section 11, the selecting section 12, the adjusting section 13, and the giving section 14. Thus, the video game processing system 100 is configured so as to: include a storage section configured to store the information regarding the in-game element so as to be associated with the user, the information being information related to the user; select at least one in-game element from the plurality of in-game elements in accordance with the predetermined rule in response to a selection request from the user; refer to the storage section to adjust a predetermined adjustment target so that the in-game element becomes a predetermined evolutive step or higher when the in-game element is given to the user on the basis of a selection result; and give the user the in-game element as the selection result or the in-game element as an adjustment result. This makes it possible to provide the user with the video game by which it is possible to maintain or further improve motivation of the user to the lottery of the in-game element.

Namely, by adjusting an evolutive step of the in-game element to be given to the user when at least one in-game element is selected from a plurality of in-game elements in accordance with the predetermined rule, it is possible to maintain or further improve motivation of the user.

In this regard, it has not been mentioned particularly as the example of the first embodiment described above. However, the video game processing system 100 may be configured so that the adjustment target is specified with a predetermined probability in accordance with the selection request by the user. By configuring the video game processing system 100 in this manner, it is possible to bring diversity to a lottery of the in-game element, and this makes it possible to maintain or further improve motivation of the user.

### Second Embodiment

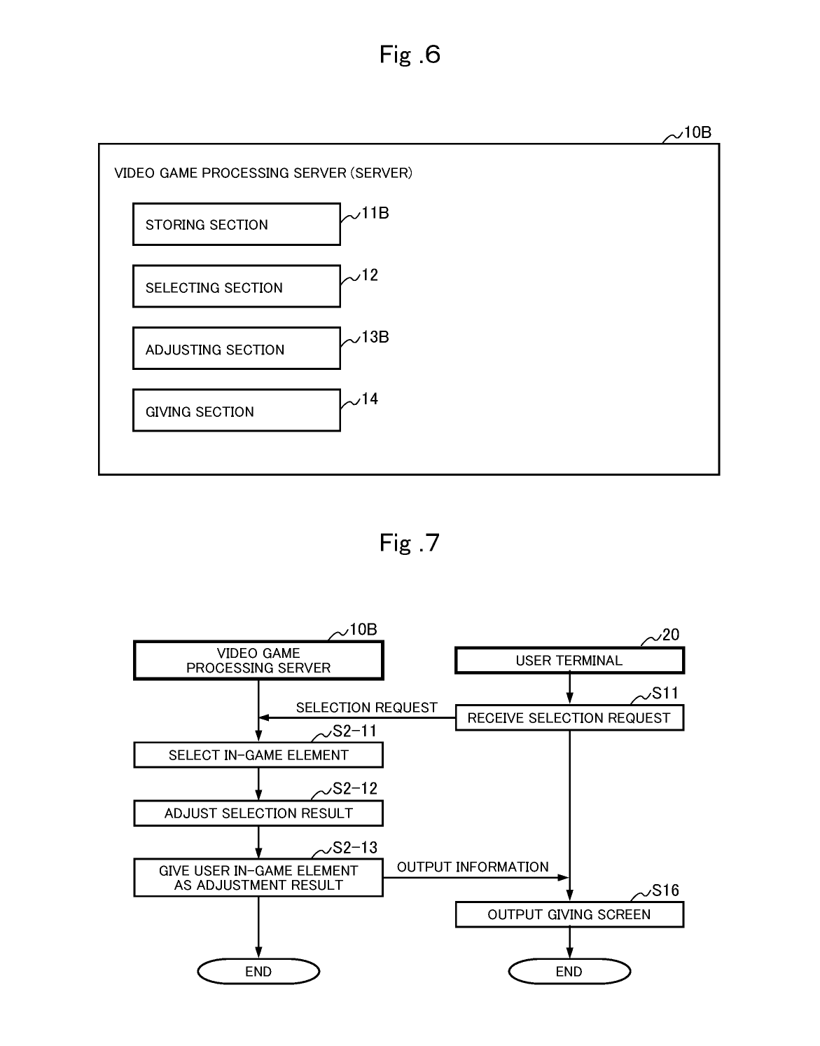

FIG. 6 is a block diagram showing a configuration of a video game processing server 10B (hereinafter, referred to as a “server 10B”), which is an example of the video game processing server 10. In the present embodiment, the server 10B at least includes a storing section 11B, a selecting section 12, an adjusting section 13B, and a giving section 14.

The storing section 11B has a function to store an in-game element that the user possesses or has possessed as information regarding the in-game element.

Here, the word “an in-game element that the user possesses” means an in-game element whose property right in the video game is certified to the user. Further, the word “an in-game element that the user has possessed” means an in-game element whose property right in the video game has been certified to the user in the past regardless of the present situation.

The adjusting section 13B has a function to adjust, when the in-game element whose evolutive step is lower than the evolutive step of the in-game element that the user possesses or has possessed is the selection result by the selecting section 12, the selection result so that an in-game element whose evolutive step is higher than that of the in-game element by at least one is to be given to the user. In this regard, a relationship between the in-game elements before and after the adjustment is not limited particularly so long as a condition for the evolutive step is satisfied. As examples of the relationship, attributes of the in-game elements (for example, a character) may be the same as each other, or may be different from each other. Further, the in-game element as the adjustment result may have an evolutive step higher than that of the in-game element as the selection result by two or higher.

FIG. 7 is a flowchart showing an example of game processing carried out by the system 100. Hereinafter, an operation of the server 10B and the terminal 20 will be described as an example. In this regard, a flowchart that shows an operation of each of the server 10B and the terminal is omitted from a point of view to avoid repeated explanation.

When a selection request is received from the terminal 20, the server 10B selects an in-game element (Step S2-11). In the present embodiment, the server 10B selects one in-game element among a plurality of in-game elements in accordance with a predetermined rule.

When the in-game element is selected, the server 10B adjusts a selection result (Step S2-12). In the present embodiment, the server 103 adjusts the selection result so that in a case where an evolutive step of the selected in-game element is lower than the evolutive step of the in-game element that the user possesses or has possessed, the in-game element is not selected but an in-game element whose evolutive step is higher than that of the in-game element by at least one is selected.

When the selection result is adjusted, the server 10B gives the user the in-game element as the adjustment result (Step S2-13). In the present embodiment, the server 10B gives the user the in-game element as the adjustment result in a case where the selection result is adjusted.

As explained above, as one side of the second embodiment, the video game processing server 10B is configured so as to include the storing section 11B, the selecting section 12, the adjusting section 13B, and the giving section 14. Thus, the video game processing server 10B is configured so as to: include the storage section in which the in-game element that the user possesses or has possessed is stored as the information regarding the in-game element; and adjust the selection result so that when an in-game element whose evolutive step is lower than the evolutive step of the in-game element that the user possesses or has possessed is a selection result, an in-game element whose evolutive step is higher than that of the in-game element by at least one is to be given to the user. This makes it possible to improve the degree of user satisfaction against the lottery of the in-game element compared with a case where there is no adjustment.

In this regard, it has not been mentioned particularly in the example of the second embodiment described above. However, the video game processing server 10B may be configured to adjust, when the in-game element whose evolutive step is lower than the evolutive step of the in-game element that the user possesses or has possessed is selected, the selection result so that an in-game element whose evolutive step is equal to or higher than an evolutive step of the in-game element that the user possesses or has possessed is to be given to the user. Namely, for example, the video game processing server 10B may be configured so that, in a case where an in-game element corresponding to an evolutive step 1 of a character A is the selection result and the user had possessed an in-game element corresponding to an evolutive step 2 of the character A in the past, the selection result is adjusted to the in-game element corresponding to the evolutive step 2 of the character A. By configuring the video game processing server 10B in this manner, especially with respect to a lottery of the in-game element in the video game in which superiority is provided to possess the same in-game element, it is possible to maintain or further improve motivation of the user. In this case, for example, the video game processing server 10B may be configured to adjust the selection result so that an in-game element whose evolutive step is the highest rank of evolutive steps of the in-game element that the user possesses or has possessed is to be given to the user. By configuring the video game processing system 100 in this manner, it is possible to maintain or further improve motivation of the user to evolve a game medium.

### Third Embodiment

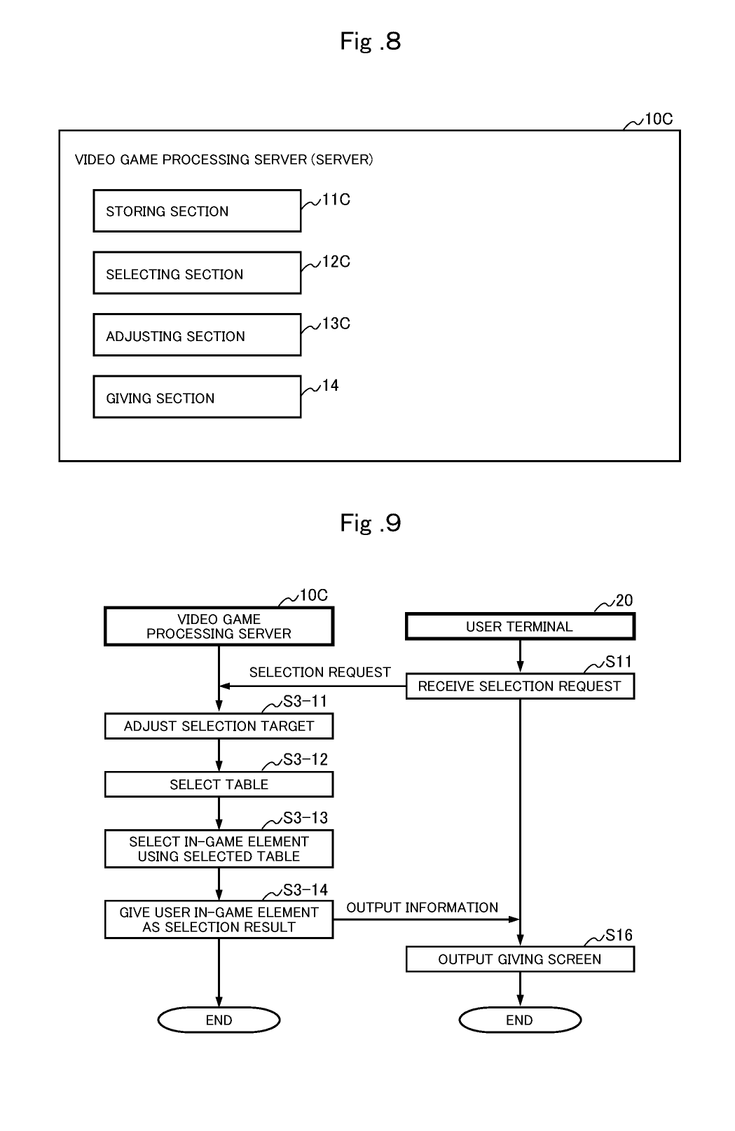

FIG. 8 is a block diagram showing a configuration of a video game processing server 10C (hereinafter, referred to as a “the server 10C”), which is an example of the video game processing server 10. In the present embodiment, the server 10C at least includes a storage section 11C, a selecting section 12C, an adjusting section 13C, and a giving section 14.

The storage section 11C stores an in-game element that the user possesses or has possessed as information regarding the in-game element to be stored.

The selecting section 12C has a function to select a table in which a selection probability is set up to each of a plurality of in-game elements from at least one tables, and to select an in-game element using the selected table.

Here, the information regarding a plurality of tables is stored in a predetermined storage region. Further, a configuration of the table is not limited particularly. However, it is preferable that the table has an information amount by which a processing load required for selection of the in-game element does not become excessively.

The adjusting section 13C has a function to adjust a selection target of the selecting section 12C so that one table is selected from at least one tables in each of which an in-game element (the exclusion target) whose evolutive step is lower than the evolutive step of the in-game element that the user possesses or has possessed is not contained. In this regard, as examples of the configuration to adjust the selection target, there are a configuration in which the predetermined number of tables each of which does not contain the exclusion target is specified as the selection target, and a configuration in which one or more tables each of which contains the exclusion target are excluded from the predetermined number of tables.

FIG. 9 is a flowchart showing an example of the game processing carried out by the system 100. Hereinafter, an operation of each of the server 10C and the terminal 20 will be described as an example. In this regard, a flowchart showing an operation of each of the server 10C and the terminal is omitted from a point of view to avoid repeated explanation.

When the selection request is received from the terminal 20, the server 10C adjusts a selection target (Step S3-11). In the present embodiment, the server 10C adjusts a selection target so that any table, in which an in-game element whose evolutive step is lower than the evolutive step of the in-game element that the user of the terminal 20 possesses or has possessed is not to be contained of the plurality of tables defined in advance as a selection target, becomes a selection target.

When the selection target is adjusted, the server 10C selects a table used for select an in-game element on the basis of the selection target after adjustment (Step S3-12). In the present embodiment, the server 10C selects one table in accordance with a predetermined rule.

When the table is selected, the server 10C selects an in-game element using the selected table (Step S3-13). In the present embodiment, the server 10C selects one in-game element on the basis of the in-game element and the selection probability set up for the table.

When the in-game element is selected, the server 10C gives the user the in-game element as the selection result (Step S3-14).

As explained above, as one side of the third embodiment, the video game processing server 10C is configured so as to include the storage section 11C, the selecting section 12C, the adjusting section 13C, and the giving section 14. Thus, the video game processing server 10C is configured so as to: include the storage section 11c in which the in-game element that the user possesses or has possessed is stored as the information regarding the in-game element; select a table, in which a selection probability is set up to each of a plurality of in-game elements, from at least one tables; select an in-game element using the selected table; and adjust a selection target (that is, the plurality of tables) so that one table is selected from the at least one tables in which an in-game element whose evolutive step is lower than the evolutive step of the in-game element that the user of the terminal 20 possesses or has possessed is not to be contained. This makes it possible to improve the degree of user satisfaction against the in-game element that can be given to the user.

### Fourth Embodiment

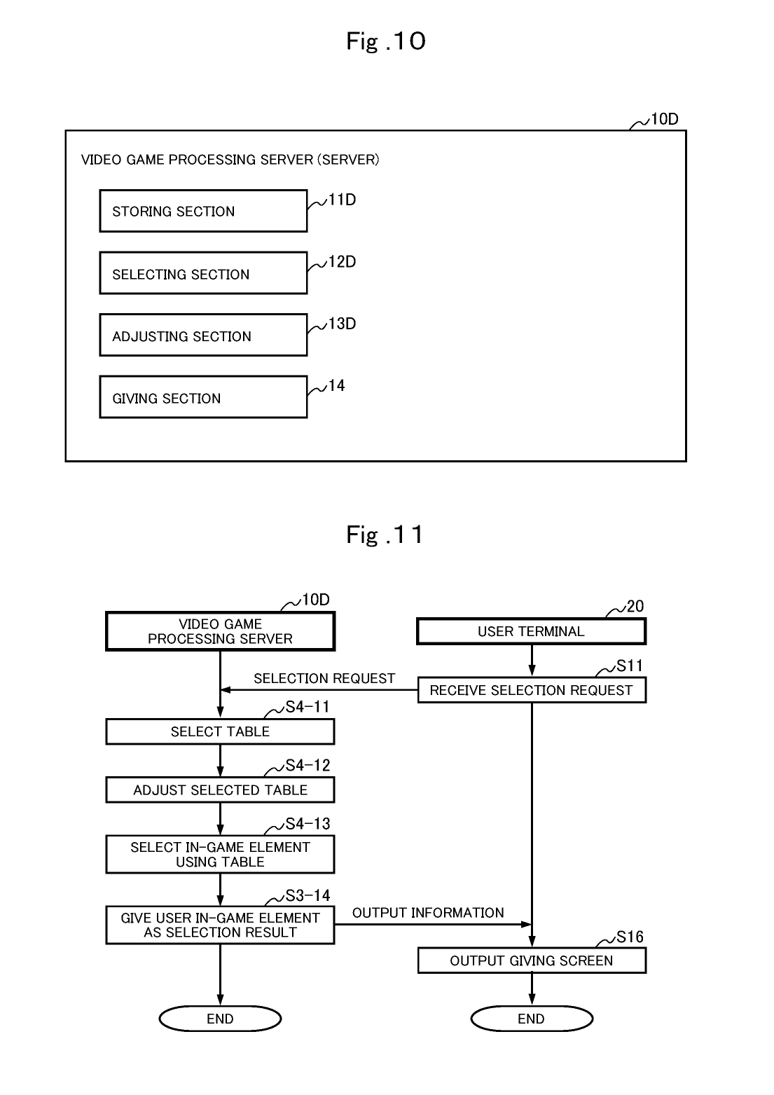

FIG. 10 is a block diagram showing a configuration of a video game processing server 10D (hereinafter, referred to as a “the server 10D”), which is an example of the video game processing server 10. In the present embodiment, the server 10D at least includes a storing section 11D, a selecting section 12D, an adjusting section 13D, and a giving section 14.

In the storing section 11D, an in-game element that the user possesses or has possessed is contained as information regarding the in-game element to be stored.

The selecting section 12D has a function to select a table, in which a selection probability is set up to each of a plurality of in-game elements, from at least one tables, and to select an in-game element using the selected table.

The adjusting section 13D has a function to adjust the table so that in a case where there is an in-game element whose evolutive step is lower than the evolutive step of the in-game element that the user possesses or has possessed (hereinafter, referred to as an “exclusion target”) in the table selected by the selecting section 12D, the in-game element is not to be contained. In this regard, as examples of the configuration to adjust the table, there are a configuration in which the exclusion target is deleted from the table to change selection probabilities of all of the in-game elements, and a configuration in which the in-game element that is the exclusion target is replaced by an in-game element whose evolutive step is higher than that of the in-game element by at least one.

FIG. 11 is a flowchart showing an example of game processing carried out by the system 100. Hereinafter, an operation of each of the server 10D and the terminal 20 will be described as an example. In this regard, a flowchart showing an operation of each of the server 10D and the terminal is omitted from a point of view to avoid repeated explanation.

When the selection request is received from the terminal 20, the server 10D selects a table (Step S4-11). In the present embodiment, the server 10D selects one table in accordance with a selection rule using identification information of the user.

When the table is selected, the server 10D adjusts the selected table (Step S4-12). In the present embodiment, the server 10D adjust the table so that in a case where an in-game element whose evolutive step is lower than the evolutive step of the in-game element that the user possesses or has possessed is contained in the selected table, the in-game element is not to be contained.

Subsequently, the server 10D selects an in-game element using the table (Step S4-13). In the present embodiment, the server 10D selects, when the table is adjusted, one in-game element on the basis of the in-game element and the selection probability set up for the table after adjustment.

As explained above, as one side of the fourth embodiment, the video game processing server 10D is configured so as to include the storing section 11D, the selecting section 12D, the adjusting section 13D, and the giving section 14. Thus, the video game processing server 10D is configured so as to: include the storage section in which the in-game element that the user possesses or has possessed is stored as the information regarding the in-game element; select a table in which a selection probability is set up to each of a plurality of in-game elements from at least one tables; select an in-game element using the selected table; and adjust, in a case where there is an in-game element whose evolutive step is lower than the evolutive step of the in-game element that the user possesses or has possessed in the selected table, the table so that the in-game element is not to be contained. This makes it possible to improve the degree of user satisfaction against the in-game element that can be given to the user.

Further, the server 10D is configured so as to replace, when the table is adjusted, the in-game element whose evolutive step is lower than the evolutive step of the in-game element that the user possesses or has possessed with a game element whose evolutive step is higher than that of the in-game element. By configuring the server 10D in this manner, the degree of satisfaction of the user can easily be increased without changing other information in the table (for example, a selection probability corresponding to each of the plurality of in-game elements contained in the table).

### Fifth Embodiment

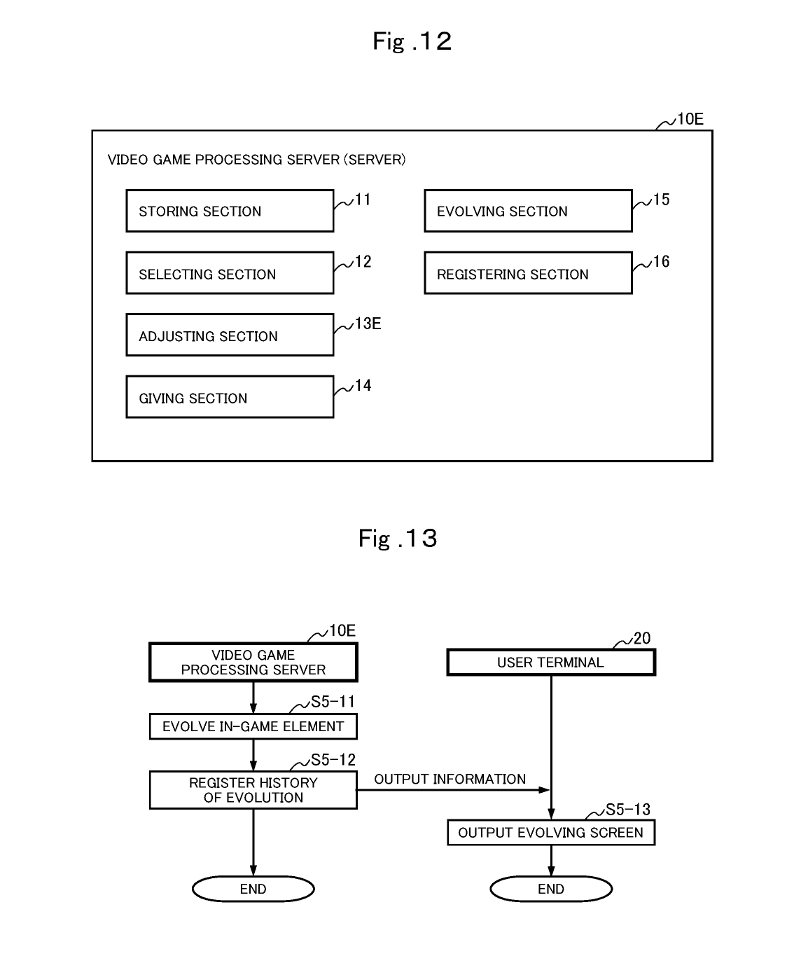

FIG. 12 is a block diagram showing a configuration of a video game processing server 10E (hereinafter, referred to as a “server 10E”), which is an example of the video game processing server 10. In the present embodiment, the server 10E at least includes a storage section 11, a selecting section 12, an adjusting section 13E, a giving section 14, an evolving section 15, and a registering section 16.

The evolving section 15 has a function to evolve an in-game element, which satisfies a predetermined evolutive condition, to an evolutive step higher than the evolutive step of the in-game element by at least one.

Here, the evolution of the in-game element means that information corresponding to the in-game element changes. Namely, the evolution according to the present embodiment includes various kinds of changes, such as an increase in various kinds of values (for example, an experience value and an offensive power) corresponding to the in-game element, a change in characters corresponding to the in-game element, a raise in a rarity corresponding to the in-game element, for example. In this regard, the content of the evolution is not limited particularly so long as it is configured so that the user can recognize the evolution. However, it is preferable that the video game processing system 100 is configured so that the evolution is treated in a different manner from normal numeral value changes. In this case, as an example of the normal numeral value change, there is so-called reinforced synthetization. As an example of the evolution, there is so-called evolution synthetization. As an example of different treatment, there is initialization of the experience value together with a raise of the rarity. In this regard, an example of the evolutive condition is not limited particularly. However, it is preferable that the higher an evolutive step is, the higher achieving difficulty becomes.

The registering section 16 has a function to register a history of the evolution in the storage section 11 as information regarding the video game when the evolving section 15 evolves the in-game element.

Here, the history of evolution means information by which the user can identify the in-game element that was evolved. Namely, in the present embodiment, the user can determine whether it is an in-game element obtained by evolution or not by referring to the history of evolution thus registered. As an example of the history of evolution, there is identification information of each of the user and the in-game element.

The adjusting section 13E has a function to adjust, when to give the user the in-game element, the in-game element whose evolutive step is lower than an evolutive step of the in-game element that the user possesses or has possessed by means of evolution.

Here, the adjusting section 13E refers to the storage section 11 to determine whether an in-game element whose evolutive step is lower than the evolutive step of “the in-game element that the user possesses by the evolution” or “the in-game element that the user has possessed by the evolution” is contained in the adjustment target or not.

Further, the word “adjustment when to give the user” means adjustment of a predetermined adjustment target. Namely, the adjusting section 13E has a function to change, when the in-game element is given to the user on the basis of the selection result by the selecting section 12, predetermined information at the time of at least one of before the selection and after the selection so that an in-game element whose evolutive step is higher than the evolutive step of the in-game element that the user possesses or has possessed by the evolution is given to the user.

FIG. 13 is a flowchart showing an example of game processing carried out by the system 100. In the game processing according to the present embodiment, a process regarding the evolution of the in-game element is carried out. Hereinafter, an operation of each of the server 10E and the terminal 20 will be described as an example. In this regard, a flowchart showing an operation of each of the server 10E and the terminal 20 is omitted from a point of view to avoid repeated explanation.

The game processing is started in a case where information regarding the evolution of the in-game element is transmitted from the terminal 20 to the server 10E, for example. Hereinafter, a case where the server 10E receives, from the terminal 20, information for specifying an in-game element to be evolved (hereinafter, referred to as a “base for evolution”) and an in-game element that becomes a material for evolution (hereinafter, referred to as a “material for evolution) will be described as an example.

In the game processing, the server 10E evolves an in-game element (Step S5-11). In the present embodiment, the server 10E increases an evolutive step of the base for evolution on the basis of information regarding each of the base for evolution and the material for evolution indicated by the information received from the terminal 20.

When the in-game element is evolved, the server 10E registers a history of the evolution (Step S5-12). In the present embodiment, the server 10E registers the user of the terminal 20 and the in-game element that was the base for evolution or the in-game element after evolution in a predetermined storage region so as to be associated with each other. Further, in the present embodiment, the server 10E generates a game screen (hereinafter, referred to as an “evolution screen”) including an image for informing the user of a result of the evolution; generates information (hereinafter, referred to as “output information”) for causing the terminal 20 to output the generated evolution screen; and transmits the generated output information to the terminal 20. Here, the configuration of the evolution screen is not limited particularly. However, it is preferable that the evolution screen is configured so that the user can recognize that the in-game element is one after evolution.

When the output information is received from the server 10E, the terminal 20 outputs the evolution screen on the basis of the received output information (Step S5-13), terminates the processing herein.

As explained above, as one side of the fifth embodiment, the video game processing server 10E is configured so as to include the storage section 11, the selecting section 12, the adjusting section 13E, the giving section 14, the evolving section 15, and the registering section 16. Thus, the video game processing server 10E is configured so as to: evolve the in-game element that satisfies the predetermined evolutive condition to an evolutive step higher than the evolutive step thereof by at least one; register, when the in-game element is evolved, the history of evolution in the storage section 11 as information regarding the video game; and carry out the adjustment of the in-game element whose evolutive step is lower than the evolutive step of the in-game element that the user possesses or has possessed by the evolution. Therefore, it is possible to improve motivation of the user to evolution.

Namely, by evolving the in-game element, it is adjusted so that an in-game element, which will be obtained by a subsequent lottery becomes one after evolution. For this reason, it is possible to provide the user with motivation to evolve the in-game element positively.

### Sixth Embodiment

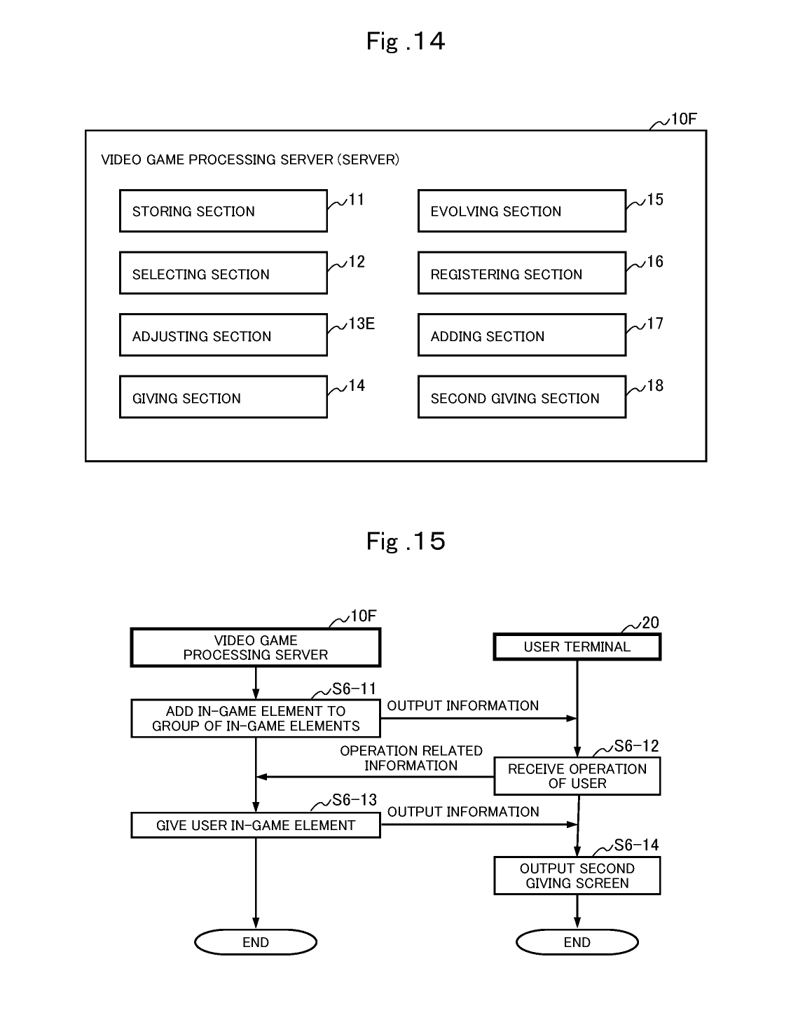

FIG. 14 is a block diagram showing a configuration of a video game processing server 10F (hereinafter, referred to as a “server 10F”), which is an example of the video game processing server 10. In the present embodiment, the server 10F at least includes a storage section 11, a selecting section 12, an adjusting section 13E, a giving section (first giving section) 14, an evolving section 15, a registering section 16, an adding section 17, and a second giving section 18.

The adding section 17 has a function to refer to the storage section 11 to add the in-game element that the user possesses or has possessed by the evolution to a predetermined group of in-game elements.

Here, the predetermined group of in-game elements means a bundle of a plurality of in-game elements created by a provider (or creator) of the video game. A configuration of the predetermined group of in-game elements is not limited particularly. However, it is preferable that a plurality of predetermined groups of in-game elements are stored so as to be associated with events in the video game. In this regard, as examples of the event, there are a so-called quest and a battle.

Further, a relationship between the in-game element to be added and the predetermined group of in-game elements is not limited particularly. However, it is preferable that, in a case where there are plural groups of in-game elements, an in-game element that can be added is defined in advance for every group of in-game elements.

The second giving section 18 has a function to give at least one in-game element of a predetermined group of in-game elements to the user who satisfies a predetermined giving condition in accordance with progress of the video game without using the function of the selecting section 12.

Here, the word “in accordance with progress of the video game” means that occurrence of various kinds of progress or changes and the like that can be generated in the video game becomes timing or a standard of a specific process. As examples of the specific process, there are a determining process, an information updating process, and the like. Further, as examples of the various kinds of progress or changes that can be generated in the video game, there are progress of time, a change in a game element value, a specific status or update of a flag, an operation input by the user, and the like.

Further, the word “without using the selecting function” means that the predetermined group of in-game elements is set up to a selection target of the in-game element. In this regard, a configuration to give the user at least one in-game element of the predetermined group of in-game elements is not limited particularly. However, it is preferable that the video game processing system 100 is configured so that the predetermined number of in-game elements is drawn from the group of in-game elements associated with a giving condition.

FIG. 15 is a flowchart showing an example of game processing carried out by the system 100. In the game processing according to the present embodiment, a process regarding an operation in which the in-game element is given to the user by the function of the second giving section 18 is carried out. Hereinafter, an operation of each of the server 10F and the terminal 20 will be described as an example. In this regard, a flowchart showing an operation of each of the server 10F and the terminal 20 is omitted from a point of view to avoid repeated explanation.

The game processing is started in a case where the server 10F receives a request to start an event, for example. Hereinafter, a case where the server 10F receives information containing the request to start the event from the terminal 20 will be described as an example.

In the game processing, the server 10F first adds the in-game element to the group of in-game elements (Step S6-11). In the present embodiment, the server 10F specifies, on the basis of the information received from the terminal 20, an in-game element that the user of the terminal 20 possesses or has possessed by evolution. Further, the server 10F specifies, on the basis of the information received from the terminal 20, an event to be provided to the user of the terminal 20 and a group of in-game elements corresponding to the event. The server 10F adds the specified in-game element to the specified group of in-game elements. Moreover, the server 10F transmits, to the terminal 20, information (the output information) for causing the terminal 20 to output various kinds of information so as to satisfy a predetermined giving condition.

When the output information is received from the server 10F, the terminal 20 receives a user operation (Step S6-12). In the present embodiment, the terminal 20 outputs a game screen on the basis of the output information, generates information relating the received user operation (hereinafter, referred to as “operation related information”), and transmits the generated operation related information to the server 10F. In this regard, the video game processing system 100 may be configured so that the output information contains image information. Alternatively, the video game processing system 100 may be configured so that the output information specifies image information stored in the terminal 20.

When the operation related information is received from the terminal 20, the server 10F gives the user the in-game element (Step S6-13). In the present embodiment, the server 10F determines whether the user satisfies the predetermined giving condition or not on the basis of the operation related information. In a case where it is determined that the user satisfies the predetermined giving condition, the in-game element is given to the user. Further, in the present embodiment, the server 10F generates information for causing the terminal 20 to output a game screen (hereinafter, referred to as a “second giving screen”) (the output information), which indicates that the in-game element is given to the user, and transmits the generated output information to the terminal 20.

When the output information is received from the server 10F, the terminal 20 outputs the second giving screen on the basis of the received output information (Step S6-14), and terminates the processing herein.

As explained above, as one side of the sixth embodiment, the video game processing server 10F is configured so as to include the storage section 11, the selecting section 12, the adjusting section 13E, the giving section (first giving section) 14, the evolving section 15, the registering section 16, the adding section 17, and the second giving section 18. Thus, the video game processing server 10F is configured so as to: refers to the storage section 11 to add the in-game element that the user possesses or has possessed to the predetermined group of in-game elements by the evolution; and give the user who satisfies the predetermined giving condition in accordance with progress of the video game at least one in-game element of the predetermined group of in-game elements without using the function of the selecting section 12. Therefore, it is possible to improve motivation of the user to evolution further.

Namely, by evolving the in-game element, an evolutive step of an in-game element that the user can obtain can be increased. Therefore, it is possible to improve motivation of the user to evolution.

### Seventh Embodiment

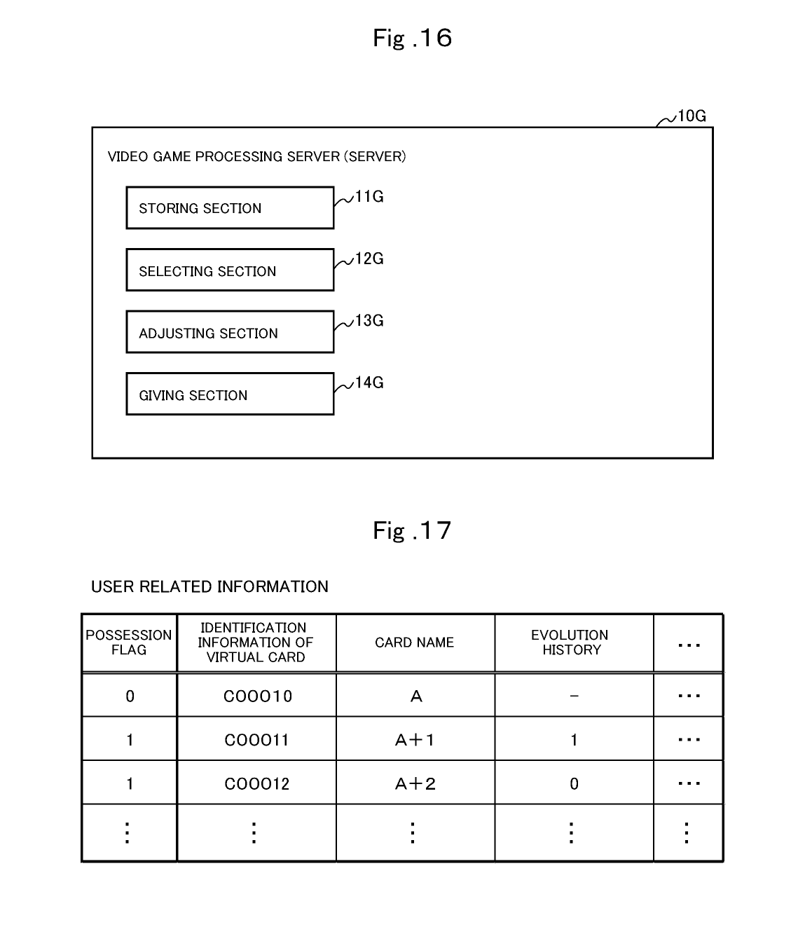

FIG. 16 is a block diagram showing a configuration of a video game processing server 10G (hereinafter, referred to as a “server 10G”), which is an example of the video game processing server 10. In the present embodiment, the server 10G at least includes a storing section 11G, a selecting section 12G, an adjusting section 13G, and a giving section 14G. Hereinafter, with respect to the words described above, each of a virtual card as the in-game element, an evolutive step of the highest rank that the user evolved for each virtual card as the predetermined evolutive step, a so-called gacha function as the selecting function, and a lottery result as the predetermined adjustment target will be described as one example.

The storing section 11G has a function to store information regarding the virtual card and related to a possession status of the user (the user related information) so as to be associated with the user.

Here, a plurality of evolutive steps is provided for a virtual card. The user can evolve the virtual card by synthesizing other virtual card with the virtual card, for example.

FIG. 17 is an explanatory drawing for explaining an example of a storage state of information stored in the storing section 11G. As shown in FIG. 17, the storing section 11G stores, as the user related information, a possession flag, identification information of a virtual card, a character name, and an evolution history so as to be associated with each of the users.

Here, the possession flag means information for identifying a virtual card possessed by the user. In the present embodiment, “1” is associated with a virtual card that the user possesses, and “0” is associated with a virtual card that the user does not possess. In this regard, the video game processing system 100 may be configured so that a possession number and a possession history can be identified in addition to these.

Further, the card name is a name of the virtual card presented to the user. In this regard, in the present embodiment, in order to explain a case where three evolutive steps are provided for a virtual card “A”, a step in which the virtual card is not evolved, a first step and a second step are respectively indicated as “A”, “A+1”, and “A+2”.

Further, the evolution history means information for identifying whether the user possesses the virtual card by the evolution or not. In the present embodiment, “1” is associated with a virtual card that has been possessed by the evolution, and “0” is associated with a virtual card that has been possessed by other method. In this regard, the video game processing system 100 may be configured so that a possession method can be identified in more detail.

The selecting section 12G has a function (gacha function) to carry out a so-called gacha in response to an operation of the user. In the present embodiment, the selecting section 12G selects one virtual card from a plurality of virtual cards in accordance with consumption of a virtual item by the user. In this regard, a configuration to select one virtual card at this time is not limited particularly. It may be configured so that one virtual card can be provided to the user at random.

The adjusting section 13G has a function to adjust a selection result by the selecting section 12G. In the present embodiment, the adjusting section 13G adjusts, when a virtual card is given to the user on the basis of the selection result by the selecting section 12G, a predetermined adjustment target so that the virtual card to be given becomes a predetermined evolutive step or higher. In the present embodiment, the adjusting section 13G adjusts the selection result so that the selection result by the selecting section 12G becomes an evolutive step that is higher than that of the virtual card that the user has possessed by evolution synthesization in the past.

Further, in the present embodiment, a plurality of evolutive steps is provided for every kind of the virtual card. The adjusting section 13G adjusts the selection result in a range where the kind of the virtual card does not change.

The giving section 14G has a function to give the user a selection result by the selecting section 12G or an adjustment result by the adjusting section 13G. In the present embodiment, the giving section 14G updates the user related information so that a virtual card to be given becomes one that the user possesses.

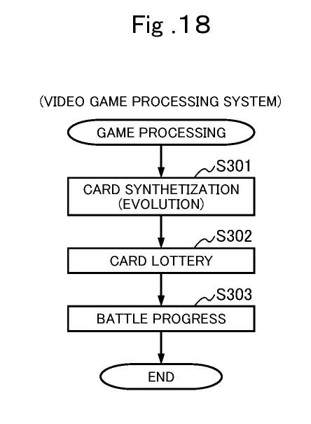

FIG. 18 is a flowchart showing an example of game processing carried out by the system 100 including the server 10G. As shown in FIG. 18, the system 100 according to the present embodiment carries out processes regarding card synthetization, a card lottery, and battle progress as processing regarding the video game. Hereinafter, each of the processes will be described. In this regard, the respective processes may be carried out in random order in a range where contradiction or the like does not occur in the content of the processing.

The system 100 carries out synthetization of virtual cards in response to an operation of the user who operates the terminal 20 (that is, a player of the video game) (Step S301).

Here, in a case where synthetization materials satisfy an evolutive condition, the virtual card is changed into a virtual card whose evolutive step is higher than that of the virtual card by one. This change is appropriately referred to as “evolution of the virtual card”.

Further, in a case where the virtual card is evolved, the user related information is updated. Namely, for example, in a case where the virtual card “A” is evolved to the virtual card “A+1”, a possession flag of the virtual card “A” becomes zero in the user related information, and the user related information is updated so that each of the possession flag and the evolution history of the virtual card “A+1” becomes one.

The system 100 carries out a lottery of a virtual card in response to an operation of the user who operates the terminal 20 (Step S302).

Here, in a case where a virtual card whose evolutive step is lower than that of the virtual card that the user had possessed by the evolution is drawn, a lottery result is adjusted. Namely, for example, in a case where a lottery result is the virtual card “A” in a situation that the user had evolved the virtual card “A” to the virtual card “A+1”, the virtual card “A+1” is given to the user. In this regard, in a case where the lottery result is the virtual card “A+2” in this situation, the virtual card “A+2” is given to the user independently of whether the user had possessed the virtual card “A+2” or not. In this regard, the video game processing system 100 may be configured so as to adjust, in a case where the lottery result is the virtual card “A” in a situation that the user had evolved the virtual card “A+1” to the virtual card “A+2”, the lottery result to the virtual card “A+1” whose evolutive step is higher by one. Alternatively, the video game processing system 100 may be configured so as to adjust the lottery result to a virtual card whose evolutive step is higher by plural steps.

Further, in a case where the virtual card is drawn, the user related information is updated. Namely, for example, in a case where the virtual card “A+1” is drawn or in a case where the virtual card “A” is adjusted to the virtual card “A+1” as the adjustment result, a possession flag of the virtual card “A+1” is set to “1” in the user related information.

The system 100 causes the battle to proceed using the virtual card (Step S303).

Here, a group of virtual cards (that is, a deck), which is organized by the virtual cards that the user possesses, is used for a battle. In this regard, the video game processing system 100 may be configured so that virtual cards possessed by other user are included in the deck. The user causes a battle using the virtual cards to proceed. Then, when the user satisfies a giving condition of a virtual card corresponding to the battle, the user can obtain a virtual card newly. In this regard, the giving condition may be a condition that can be satisfied in the middle of progress of the battle, or may be a condition that is satisfied at the end of the battle.

Further, a plurality of battles are provided in the video game, and a drop item is associated with each of the battles. Namely, when the user satisfies a giving condition in each of the battles, the user can obtain the corresponding drop item. Further, the drop item according to the present embodiment can be increased when the user evolves the virtual card. Namely, for example, in a case where the virtual card “A” as the drop item is associated with a battle B1, the user evolves the virtual card “A” to the virtual card “A+1” , and the virtual card “A+1” is then also associated with the battle B1. In this regard, unlike the lottery of the virtual card, the virtual card after the evolution is merely added to the drop item, and the virtual card before the evolution is not excluded from the drop item.

Further, in a case where the user satisfies the giving condition in accordance with progress of the battle or a result of the battle, the user related information is updated. Namely, for example, in a case where the user satisfies a giving condition of the virtual card “A+1”, the possession flag of the virtual card “A+1” is set to “1” in the user related inf ormat ion.

As explained above, as one side of the seventh embodiment, the video game processing server 10G is configured so as to include the storing section 11G, the selecting section 12G, the adjusting section 13G, and the giving section 14G. Thus, the video game processing server 10G is configured so as to: include the storage section for storing the information regarding the in-game element so as to be associated with the user, the information being information related to the user; select at least one in-game element from a plurality of in-game elements in response to a selection request from the user in accordance with a predetermined rule; refer, when the in-game element is given to the user on the basis of a selection result, to the storage section to adjust the predetermined adjustment target so that the in-game element becomes a predetermined evolutive step or higher; and give the user the in-game element as the selection result or the in-game element as an adjustment result. Therefore, it possible to provide the user with the video game by which it is possible to maintain or improve motivation of the user to the lottery of the in-game element.

Further, as one side of the seventh embodiment, the video game processing server 10G is configured so that the plurality of evolutive steps is provided for every kind of the in-game element (for example, the virtual card) (for example, “A”, “A+1” and “A+2” for the virtual card “A”), and so as to carry out the adjustment in a range where the kind of the in-game element does not change (for example, the virtual card “A+1” is given to the user when the virtual card “A” is selected). Therefore, it is possible to prevent the content of the adjustment from being unclear for the user. However, the adjustment may be one by which it is possible to maintain or improve motivation of the user to the lottery of the in-game element. For example, the video game processing server 10G may be configured so that a kind of the in-game element after the adjustment is different from a kind of the in-game element before the adjustment, and an evolutive step or the other element (for example, a rarity) of the in-game element after the adjustment is set up to be higher than that of the in-game element before the adjustment.

In this regard, it has not been mentioned particularly in the example of the seventh embodiment described above. However, the video game processing server 10G maybe configured so as to carry out the adjustment in a case where a selection request is received in a period of time after the evolution was carried out until a predetermined period of time elapses. Namely, for example, the server 10G may be configured so as to: store the date and time when the virtual card “A” is evolved to the virtual card “A+1” in response to an operation of the user of the terminal 20 in a predetermined storage device; and give this user the virtual card “A+1” in a case where a lottery result of the virtual card according to a selection request by this user in a period of time from the stored date and time until a predetermined period of time (for example, 24 hours) elapses is the virtual card “A” . By configuring the video game processing system 100 in this manner, it is possible to maintain or further improve motivation of the user to the lottery of the in-game element.

In this regard, it has not been mentioned particularly in the example of the seventh embodiment described above. However, the video game processing server 10G may be configured to adjust, when the in-game element whose evolutive step is lower than the evolutive step of the in-game element that the user possesses or has possessed is the selection result, the predetermined adjustment target so that an in-game element whose evolutive step is the highest rank of evolutive steps of the in-game element that the user possesses or has possessed is to be given to the user. Namely, for example, in a case where the virtual card “A” is selected in response to an operation of the user of the terminal 20 and an evolutive step of the highest rank of the virtual card “A” possessed by this user is the virtual card “A+2”, the video game processing system 100 may be configured so that the virtual card “A+2” is given to the user instead of the virtual card “A”. By configuring the video game processing system 100 in this manner, it is possible to maintain or improve motivation of the user to evolution of the in-game element.

As explained above, one or two or more shortages are solved by each of the embodiments of the present application. In this regard, the effects by each of the embodiments are non-limiting effects or one example of effects.

In this regard, in each of the embodiments described above, each of the plurality of user terminals 20 and 201 to 20N and the video game processing server 10 carries out the various kinds of processing described above in accordance with various kinds of control programs (for example, a video game processing program) stored in the storage device with which the corresponding terminal or server is provided.

Further, the configuration of the video game processing system 100 is not limited to the configuration that has been explained as the example of the respective embodiments described above. For example, the video game processing system 100 may be configured so that part or all of the processing that has been explained as the processing carried out by the user terminal is carried out by the server 10, or it maybe configured so that part or all of the processing that has been explained as the processing carried out by the server 10 is carried out by any of the plurality of user terminals 20 and 201 to 20N (for example, the user terminal 20). Further, it may be configured so that a part or all of the storing sections included by the server 10 is included in any of the plurality of user terminals 20 and 201 to 20N. Namely, it may be configured so that a part or all of the functions included in any one of the user terminal 20 1 and the video game processing server 10 according to the video game processing system 100 is included in the other.

Further, the video game processing program may be configured so as to cause a single video game processing apparatus that does not include a communication network to realize a part or all of the functions that have been explained as the examples of the respective embodiments described above.

(Appendix)

The explanation of the embodiments described above has been described so that the following inventions can be at least realized by a person having a normal skill in the art to which the present invention belongs.

(1)

A non-transitory computer-readable medium including a video game processing program product for causing a server to realize functions to control progress of a video game, an in-game element for which a plurality of evolutive steps are provided appearing in the video game, the server comprising a storage section configured to store information regarding the in-game element so as to be associated with a user, the information being information related to the user,

wherein the functions include:

a selecting function configured to select at least one in-game element from a plurality of in-game elements in accordance with a predetermined rule in response to a selection request from the user;

an adjusting function configured to refer to the storage section to adjust a predetermined adjustment target so that the in-game element becomes a predetermined evolutive step or higher when the in-game element is given to the user on the basis of a selection result by the selecting function; and

a giving function configured to give the user the in-game element as the selection result by the selecting function or the in-game element as an adjustment result by the adjusting function.

(2)

The non-transitory computer-readable medium according to claim (1),

wherein an in-game element that the user possesses or has possessed is stored in the storage section as the information regarding the in-game element, and

wherein the adjusting function includes a function configured to adjust the selection result so that when the in-game element whose evolutive step is lower than an evolutive step of the in-game element that the user possesses or has possessed is the selection result by the selecting function, an in-game element whose evolutive step is higher than that of the in-game element by at least one is to be given to the user.

(3)

The non-transitory computer-readable medium according to claim (1),

wherein the in-game element that the user possesses or has possessed is stored in the storage section as the information regarding the in-game element,

wherein the selecting function includes a function configured to select a table, in which selection probabilities are respectively set up to the plurality of in-game elements from at least one tables, and to select an in-game element using the selected table, and

wherein the adjusting function includes a function configured to adjust a selection target by the selecting function so that one table is selected from one or more tables each of which does not include an in-game element whose evolutive step is lower than an evolutive step of the in-game element that the user possesses or has possessed.

(4)

The non-transitory computer-readable medium according to claim (1),

wherein the in-game element that the user possesses or has possessed is stored in the storage section and the information regarding the in-game element,

wherein the selecting function includes a function configured to select a table, in which selection probabilities are respectively set up to the plurality of in-game elements from at least one tables, and to select an in-game element using the selected table, and

wherein the adjusting function includes a function configured to adjust the table so as not to include the in-game element in a case where there is an in-game element whose evolutive step is lower than an evolutive step of the in-game element that the user possesses or has possessed in the table selected by the selecting function.

(5)

The non-transitory computer-readable medium according to any one of claims (1) to (4),

wherein the functions further include:

an evolving function configured to evolve the in-game element that satisfies a predetermined evolutive condition to an evolutive step higher than the evolutive step of the in-game element by at least one; and

a registering function configured to register the history of evolution in the storage section as information regarding the video game when the evolving function evolves the in-game element, and

wherein the adjusting function includes a function configured to adjust, by the evolution, the in-game element whose evolutive step is lower than the evolutive step of the in-game element that the user possesses or has possessed.

(6)

The non-transitory computer-readable medium according to claim (5),

wherein the functions further include:

an adding function configured to refer to the storage section to add the in-game element that the user possesses or has possessed by the evolution to the predetermined group of in-game elements; and

a second giving function configured to give at least one in-game element of the predetermined group of in-game elements to the user who satisfies a predetermined giving condition in accordance with progress of the video game without using the selecting function.

(7)

The non-transitory computer-readable medium according to claim (5) or (6),

wherein the adjusting function includes a function configured to carry out the adjustment in a case where the selection request is received in a period of time after the evolution was carried out until a predetermined period of time elapses.

(8)

The non-transitory computer-readable medium according to any one of claims (1) to (7),

wherein a plurality of evolutive steps is provided for every kind of the in-game element, and

wherein the adjusting function includes a function configured to carry out the adjustment in a range where the kind of the in-game element does not change.

(9)

The non-transitory computer-readable medium according to any one of claims (1) to (8),

wherein the adjusting function includes a function configured to adjust, when the in-game element whose evolutive step is lower than the evolutive step of the in-game element that the user possesses or has possessed is the selection result by the selecting function, the predetermined adjustment target so that an in-game element whose evolutive step is the highest rank of evolutive steps of the in-game element that the user possesses or has possessed is to be given to the user.

(10)

A non-transitory computer-readable medium including a video game processing program product for causing a user terminal to realize at least one function of the functions that the server is caused to realize in accordance with the non-transitory computer-readable medium according to any one of claims (1) to (9), the user terminal being allowed to communicate with the server.

(11)

A server in which the video game processing program described in any one of claims (1) to (10) is installed.

(12)

A video game processing system including a communication network, a server and a user terminal, the video game processing system being configured to control progress of a video game, an in-game element for which a plurality of evolutive steps are provided appearing in the video game, the video game processing system comprising:

a storing section configured to store information regarding the in-game element so as to be associated with a user, the information being information related to the user;

a selecting section configured to select at least one in-game element from a plurality of in-game elements in accordance with a predetermined rule in response to a selection request from the user;

an adjusting section configured to refer to the storage section to adjust a predetermined adjustment target so that the in-game element becomes a predetermined evolutive step or higher when the in-game element is given to the user on the basis of a selection result by the selecting section; and

a giving section configured to give the user the in-game element as the selection result by the selecting section or the in-game element as an adjustment result by the adjusting section.

(13)

The video game processing system according to claim (12),

wherein the server comprises the storing section, the selecting section, the adjusting section, and the giving section, and

wherein the user terminal comprises:

an outputting section configured to output a game screen to a display screen of a display device, the game screen indicating a giving result by the giving section.

(14)

A non-transitory computer-readable medium including a video game processing program product for causing a user terminal to realize functions to control progress of a video game, an in-game element for which a plurality of evolutive steps are provided appearing in the video game, the user terminal communicating with a server, the server comprising a storage section configured to store information regarding the in-game element so as to be associated with a user, the information being information related to the user,

wherein the server includes:

a selecting function configured to select at least one in-game element from a plurality of in-game elements in accordance with a predetermined rule in response to a selection request from the user;

an adjusting function configured to refer to the storage section to adjust a predetermined adjustment target so that the in-game element becomes a predetermined evolutive step or higher when the in-game element is given to the user on the basis of a selection result by the selecting function; and

a giving function configured to give the user the in-game element as the selection result by the selecting function or the in-game element as an adjustment result by the adjusting function,

wherein the functions includes:

a receiving function configured to receive, from the server, information for outputting a game screen indicating a giving result by the giving function.

(15)

A non-transitory computer-readable medium including a video game processing program product for causing a user terminal to realize functions to control progress of a video game, an in-game element for which a plurality of evolutive steps are provided appearing in the video game, the user terminal comprising a storage section configured to store information regarding the in-game element so as to be associated with a user, the information being information related to the user,

wherein the functions include:

a selecting function configured to select at least one in-game element from a plurality of in-game elements in accordance with a predetermined rule in response to a selection request from the user;

an adjusting function configured to refer to the storage section to adjust a predetermined adjustment target so that the in-game element becomes a predetermined evolutive step or higher when the in-game element is given to the user on the basis of a selection result by the selecting function; and

a giving function configured to give the user the in-game element as the selection result by the selecting function or the in-game element as an adjustment result by the adjusting function.

(16)

The non-transitory computer-readable medium according to claim (15),

wherein a server is caused to realize at least one function of the functions that the user terminal is caused to realize, the server being capable of communicating with the user terminal.

(17)

A user terminal into which the video game processing program included in the non-transitory computer-readable medium according to claim (15) or (16) is installed.

(18)

A video game processing method of controlling progress of a video game, an in-game element for which a plurality of evolutive steps are provided appearing in the video game, the video game processing method comprising:

a selecting process configured to select at least one in-game element from a plurality of in-game elements in accordance with a predetermined rule in response to a selection request from the user;

an adjusting process configured to refer to a storage section to adjust a predetermined adjustment target so that the in-game element becomes a predetermined evolutive step or higher when the in-game element is given to the user on the basis of a selection result in the selecting process, the storage section being configured to store information regarding the in-game element so as to be associated with the user, the information being information related to the user; and

a giving process configured to give the user the in-game element as the selection result in the selecting process or the in-game element as an adjustment result in the adjusting process.

(19)

A video game processing method carried out by a video game processing system for controlling progress of a video game, the video game processing system comprising a communication network, a server and a user terminal, an in-game element for which a plurality of evolutive steps are provided appearing in the video game, the video game processing method comprising:

a selecting process configured to select at least one in-game element from a plurality of in-game elements in accordance with a predetermined rule in response to a selection request from the user;

an adjusting process configured to refer to a storage section to adjust a predetermined adjustment target so that the in-game element becomes a predetermined evolutive step or higher when the in-game element is given to the user on the basis of a selection result in the selecting process, the storage section being configured to store information regarding the in-game element so as to be associated with the user, the information being information related to the user; and

a giving process configured to give the user the in-game element as the selection result in the selecting process or the in-game element as an adjustment result in the adjusting process.

According to one of the embodiments of the present invention, it is useful to provide a user with a video game capable of maintaining or improving a motivation of a user to a lottery of an in-game element.

What is claimed is:

1. A non-transitory computer-readable medium including a video game processing program product for causing a server to realize functions to control progress of a video game, an in-game element for which a plurality of evolutive steps are provided appearing in the video game, the server comprising a storage section configured to store information regarding the in-game element so as to be associated with a user, the information being information related to the user,
wherein the functions include:
a selecting function configured to select at least one in-game element from a plurality of in-game elements in accordance with a predetermined rule in response to a selection request from the user;
an adjusting function configured to refer to the storage section to adjust a predetermined adjustment target so that the in-game element becomes a predetermined evolutive step or higher when the in-game element is given to the user on the basis of a selection result by the selecting function; and
a giving function configured to give the user the in-game element as the selection result by the selecting function or the in-game element as an adjustment result by the adjusting function.

2. The non-transitory computer-readable medium according to claim 1,
wherein an in-game element that the user possesses or has possessed is stored in the storage section as the information regarding the in-game element, and
wherein the adjusting function includes a function configured to adjust the selection result so that when the in-game element whose evolutive step is lower than an evolutive step of the in-game element that the user possesses or has possessed is the selection result by the selecting function, an in-game element whose evolutive step is higher than that of the in-game element by at least one is to be given to the user.

3. The non-transitory computer-readable medium according to claim 1,
wherein the in-game element that the user possesses or has possessed is stored in the storage section as the information regarding the in-game element,
wherein the selecting function includes a function configured to select a table, in which selection probabilities are respectively set up to the plurality of in-game elements from at least one tables, and to select an in-game element using the selected table, and
wherein the adjusting function includes a function configured to adjust a selection target by the selecting function so that one table is selected from one or more tables each of which does not include an in-game element whose evolutive step is lower than an evolutive step of the in-game element that the user possesses or has possessed.

4. The non-transitory computer-readable medium according to claim 1,
wherein the in-game element that the user possesses or has possessed is stored in the storage section and the information regarding the in-game element,
wherein the selecting function includes a function configured to select a table, in which selection probabilities are respectively set up to the plurality of in-game elements from at least one tables, and to select an in-game element using the selected table, and
wherein the adjusting function includes a function configured to adjust the table so as not to include the in-game element in a case where there is an in-game element whose evolutive step is lower than an evolutive step of the in-game element that the user possesses or has possessed in the table selected by the selecting function.

5. The non-transitory computer-readable medium according to claim 1, further comprising:
wherein the functions further include:
an evolving function configured to evolve the in-game element that satisfies a predetermined evolutive condition to an evolutive step higher than the evolutive step of the in-game element by at least one; and
a registering function configured to register the history of evolution in the storage section as information regarding the video game when the evolving function evolves the in-game element, and
wherein the adjusting function includes a function configured to adjust, by the evolution, the in-game element whose evolutive step is lower than the evolutive step of the in-game element that the user possesses or has possessed.

6. The non-transitory computer-readable medium according to claim 5,
wherein the functions further include:
an adding function configured to refer to the storage section to add the in-game element that the user possesses or has possessed by the evolution to the predetermined group of in-game elements; and
a second giving function configured to give at least one in-game element of the predetermined group of in-game elements to the user who satisfies a predetermined giving condition in accordance with progress of the video game without using the selecting function.

7. The non-transitory computer-readable medium according to claim 1,
wherein the adjusting function includes a function configured to adjust, when the in-game element whose evolutive step is lower than the evolutive step of the in-game element that the user possesses or has possessed is the selection result by the selecting function, the predetermined adjustment target so that an in-game element whose evolutive step is the highest rank of evolutive steps of the in-game element that the user possesses or has possessed is to be given to the user.

8. A video game processing system including a communication network, a server and a user terminal, the video game processing system being configured to control progress of a video game, an in-game element for which a plurality of evolutive steps are provided appearing in the video game, the video game processing system comprising:
a storing section configured to store information regarding the in-game element so as to be associated with a user, the information being information related to the user;
a selecting section configured to select at least one in-game element from a plurality of in-game elements in accordance with a predetermined rule in response to a selection request from the user;
an adjusting section configured to refer to the storage section to adjust a predetermined adjustment target so that the in-game element becomes a predetermined evolutive step or higher when the in-game element is given to the user on the basis of a selection result by the selecting section; and
a giving section configured to give the user the in-game element as the selection result by the selecting section or the in-game element as an adjustment result by the adjusting section.

9. A non-transitory computer-readable medium including a video game processing program product for causing a user terminal to realize functions to control progress of a video game, an in-game element for which a plurality of evolutive steps are provided appearing in the video game, the user terminal communicating with a server, the server comprising a storage section configured to store information regarding the in-game element so as to be associated with a user, the information being information related to the user,
wherein the server includes:
a selecting function configured to select at least one in-game element from a plurality of in-game elements in accordance with a predetermined rule in response to a selection request from the user;
an adjusting function configured to refer to the storage section to adjust a predetermined adjustment target so that the in-game element becomes a predetermined evolutive step or higher when the in-game element is given to the user on the basis of a selection result by the selecting function; and
a giving function configured to give the user the in-game element as the selection result by the selecting function or the in-game element as an adjustment result by the adjusting function,
wherein the functions includes:
a receiving function configured to receive, from the server, information for outputting a game screen indicating a giving result by the giving function.
